(19) United States
(12) Patent Application Publication
(10) Pub. No.: US 2025/0349853 A1
(43) Pub. Date: Nov. 13, 2025

(54) BATTERY CATHODES CONTAINING MXENES PROCESSED FROM WATER-BASED SLURRIES

(71) Applicant: DREXEL UNIVERSITY, Philadelphia, PA (US)

(72) Inventors: Armin VAHIDMOHAMMADI, Horsham, PA (US); Yury GOGOTSI, Warminster, PA (US)

(21) Appl. No.: 18/862,708

(22) PCT Filed: May 4, 2023
(86) PCT No.: PCT/US2023/066590

§ 371 Date: Nov. 4, 2024

Related U.S. Application Data
(60) Provisional application No. 63/364,216, filed on May 5, 2022.

(51) Int. Cl. H01M 4/62; H01M 4/02; H01M 4/04; H01M 4/131; H01M 4/1391

(52) U.S. Cl. CPC H01M 4/621; H01M 4/0404; H01M 4/0435; H01M 4/131; H01M 4/1391; H01M 4/624; H01M 2004/021; H01M 2004/028

(57) ABSTRACT

A method, comprising: combining at least a MXene, a solvent, and an electrochemically active material to form a slurry, the solvent consisting essentially of water, alcohol, or a combination of alcohol and water. An electrode, comprising: a structure comprising a MXene and an electrochemically active material, the structure optionally having a cross-sectional dimension of from about 1 to about 300 μm in thickness, preferably from about 10 to about 100 μm; and optionally a substrate on which the film is disposed. A device, the device comprising an electrode according to the present disclosure (for example, according to any one of Aspects 14-19). A method, comprising operating a device according to the present disclosure (for example, according to any one of Aspects 21-22).

### CROSS-REFERENCE TO RELATED APPLICATIONS

The present application claims priority to and the benefit of U.S. patent application No. 63/364,216, “Battery Cathodes Containing MXenes Processed From Water-Based Slurries” (filed May 5, 2022). All foregoing applications are incorporated herein by reference in their entireties for any and all purposes.

### TECHNICAL FIELD

The present disclosure relates to the field of battery electrode processing and composition and to the field MXene materials.

### BACKGROUND

Existing approaches to form battery electrodes often utilize toxic solvents such as N-Methyl-2-pyrrolidone (NMP), and also often include other additives, such as non-conductive polymeric binders (such as PVDF, CMC, and the like) and also conductive carbon additives. The use of these additives and solvents results in added—and unwanted—complexity and cost. Accordingly, there is a long-felt need in the art for improved methods of forming battery electrode structures.

### SUMMARY

In meeting the described long-felt needs, the present disclosure provides a method, comprising: combining at least a MXene, a solvent, and an electrochemically active material to form a slurry, the solvent consisting essentially of water, alcohol, or a combination of alcohol and water.

Also provided is an electrode, comprising: a structure comprising a MXene and an electrochemically active material, the structure optionally having a cross-sectional dimension of from about 1 to about 300 μm in thickness, preferably from about 10 to about 100 μm; and optionally a substrate on which the film is disposed.

Further disclosed is a device, the device comprising an electrode according to the present disclosure (for example, according to any one of Aspects 14-19).

Also provided is a method, comprising operating a device according to the present disclosure (for example, according to any one of Aspects 21-22).

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 provides a schematic representation of the polymeric binder-free cathode compositions with at least 85 wt. % of active material powder in the cathode composition, processed through water-based slurries with Ti₃C₂ MXene additives.

FIG. 2 illustrates polymeric binder-free NMC 811 cathodes with 90 wt. % of active material powder in the cathode composition, processed through water-based slurries with Ti₃C₂ MXene additives.

FIG. 3 illustrates charge discharge profiles of a polymeric binder-free NMC 811 cathodes with 97 wt. % of active material powder in the cathode composition, processed through water-based slurries with Ti₃C₂ MXene additives. The cathode has an active material loading of ˜29.35 mg cm⁻² and at C/8 rate could deliver areal capacities of ˜4.9 mAh cm⁻² and 4 mAh cm⁻² at 4.3V and 4.2 V, respectively.

FIG. 4 illustrates polymeric binder-free (a) NMC622 and (b) NCA, cathodes with 95 wt. % of NMC622 and 98 wt. % of NCA active material powders in the cathode composition, respectively, processed through water-based slurries with Ti₃C₂ MXene additives.

FIG. 5 illustrates (a) Charge discharge profiles of a polymeric binder-free NMC622 with 97 wt. % of active material powder in the cathode composition, processed through water-based slurries with Ti₃C₂ MXene additives at a rate of C/4, and (b) Cycle life performance of a polymeric binder-free NMC622 with 90 wt. % of active material powder in the cathode composition processed through water-based slurries with Ti₃C₂ MXene additives at a rate of C/2.

FIG. 6 illustrates (a) Scanning electron microscope (SEM) image from a cross section of a NCA cathode with 95 wt. % active material powder in the electrode composition, processed through water-based slurries with Ti₃C₂ MXene additives. (b) Charge discharge profiles of a NCA cathode with 95 wt. % active material powder in the electrode composition, processed through water-based slurries with Ti₃C₂ MXene additives. The cathode has an active material loading of ˜14 mg cm⁻² and an areal capacity of ˜2.6 mAh cm⁻² at C/4 rate.

FIG. 7 provides charge discharge profiles of a NCA cathode with 98 wt. % active material powder in the electrode composition, processed through water-based slurries with Ti₃C₂ MXene additives at (a) C/8 and (b) C/2 rates. The cathode has an active material loading of ˜12 mg cm⁻² and an aerial capacity of ˜2.3 mAh cm⁻² at C/8 rate.

FIG. 8 illustrates comparative conventional electrodes prepared with NMC, carbon, and PVDF by using NMP as solvent.

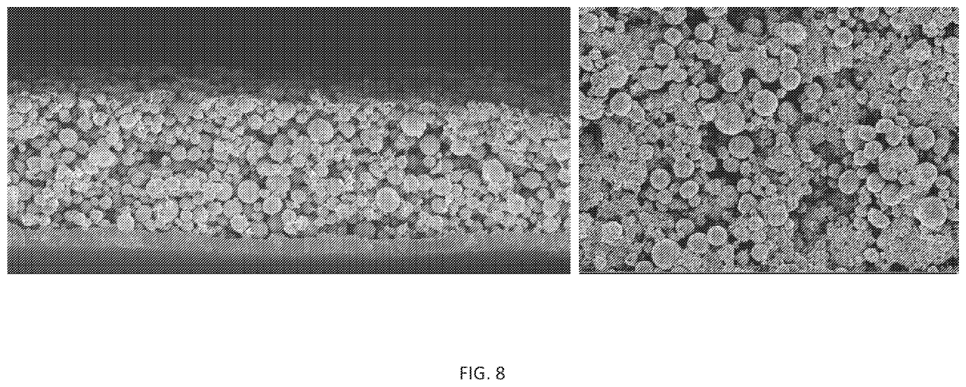

FIG. 9 provides X-ray diffraction patterns of the cathode active materials, either processed by conventional water-free slurry methods (for NMC) or the pristine powder themselves (for LFP), and compares them to the electrodes processed by the disclosed water containing slurry processing techniques using MXenes. As can be seen, the disclosed processing does not result in phase or structural change of the cathode active materials because of the presence of water in the slurry formulation. The relative intensity of peaks and peak positions for both NMC811 and LFP active materials also remained unchanged, further indicating minimal effects of the disclosed novel slurry processing techniques on the physical properties of the active materials. In the NMC811-MX cathode at low angles the (002) reflection peak of MXene can also be observed which suggests presence of oriented MXene flakes along their basal planes in the cathode architecture.

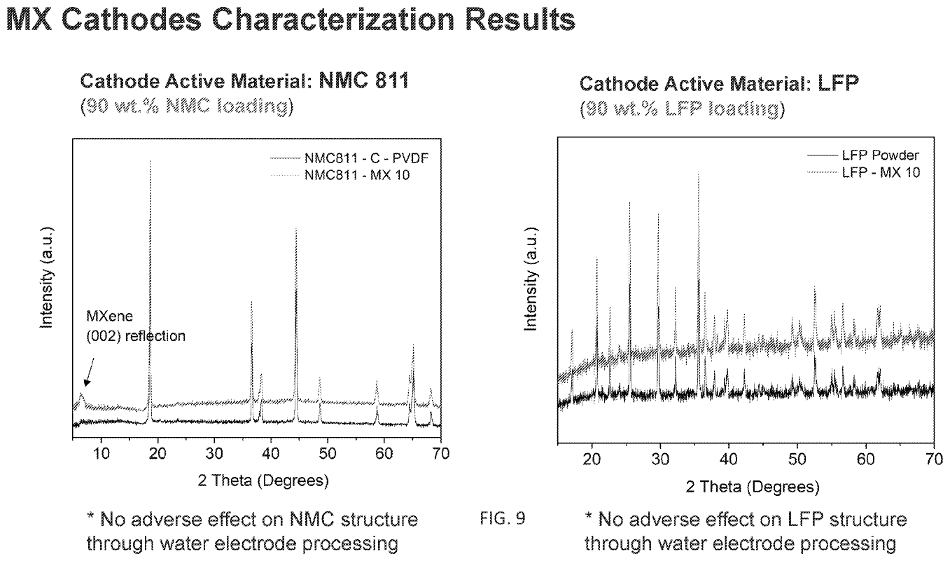

FIG. 10 provides (left) scanning electron microscopy (SEM) images of the cross section of NMC811-MXene cathode with 95 wt. % active material (top left image) and a conventional NMC811-carbon-PVDF cathode with 95 wt. % active material (bottom left image) are shown. Based on the observed microstructure in the SEM image, in the disclosed novel cathode structures, active material particles are wrapped with MXene flakes (creating a surface protection for the active materials), are intertwined with MXene flakes within the bulk of the electrodes and are sandwiched between two layers of oriented MXene layers at the top and bottom. The right panel shows voltage profiles of an NMC811-MXene cathode and a convectional NMC-C-PVDF cathode in a Li-ion half-cell (vs Li metal as anode) cycled between 2.8 V and 4.2 V (vs Li/Li⁺) at a rate of 0.32C. Both electrodes have 90 wt. % active material in their composition but the NMC-MXene cathode has 1.5X mass loading of the convectional electrode. Despite this, the NMC-MXene cathode delivers an identical capacity and voltage profile curves to the conventional NMC cathode with slightly reduced voltage polarization indicating to the improved kinetics and electrical conductivity of the new cathode structures.

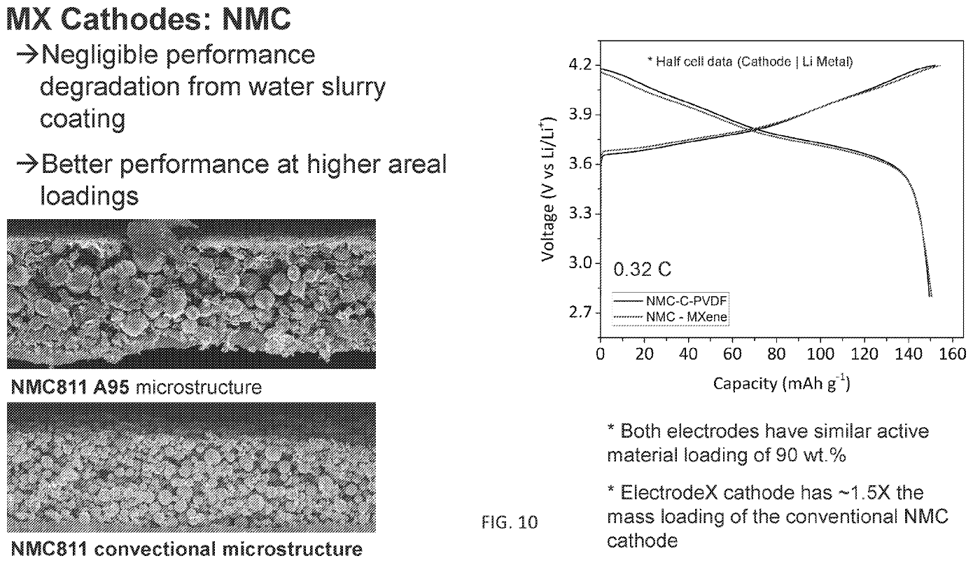

FIG. 11 provides (left) digital images of exemplary NMC811-MXene cathodes with 95 wt. % active material in their composition and an areal capacity of 2 mAh cm⁻² (left image-cathode coated on a carbon coated Al foil as the current collector). The right image of FIG. 11 shows a punched and calendared cathode used for testing in coin cells.

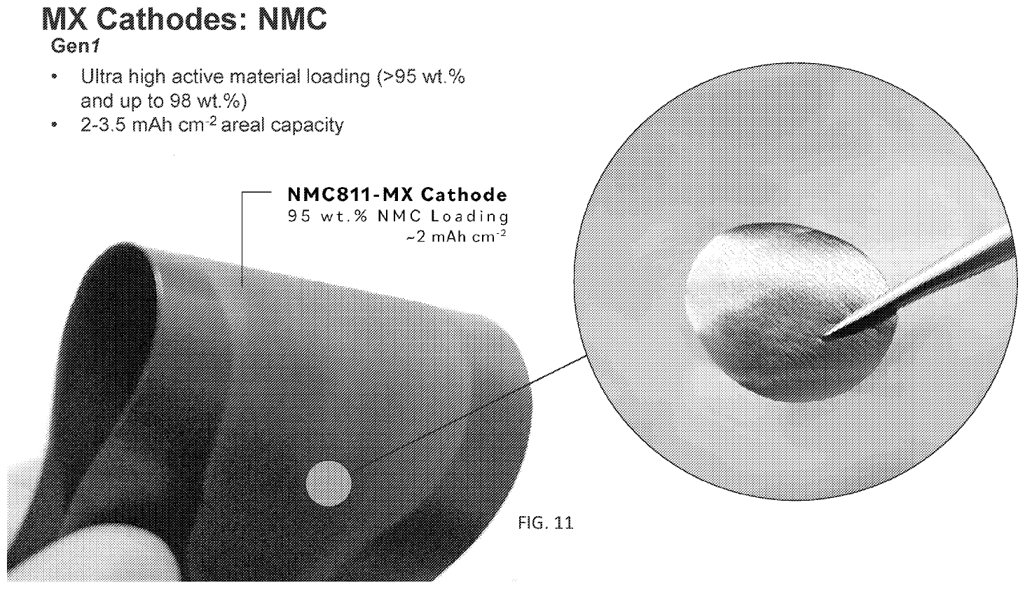

FIG. 12 provides images of an example NMC622 cathode processed with the disclosed new technology. The cathode contains 95 wt. % NMC622 active material and is coated on a regular Al foil current collector. Different images are provided of the bent electrodes, showing the good adhesion of the coated cathode film on the current collector using the disclosed MXene additive in the electrode structure and without using PVDF polymeric binder.

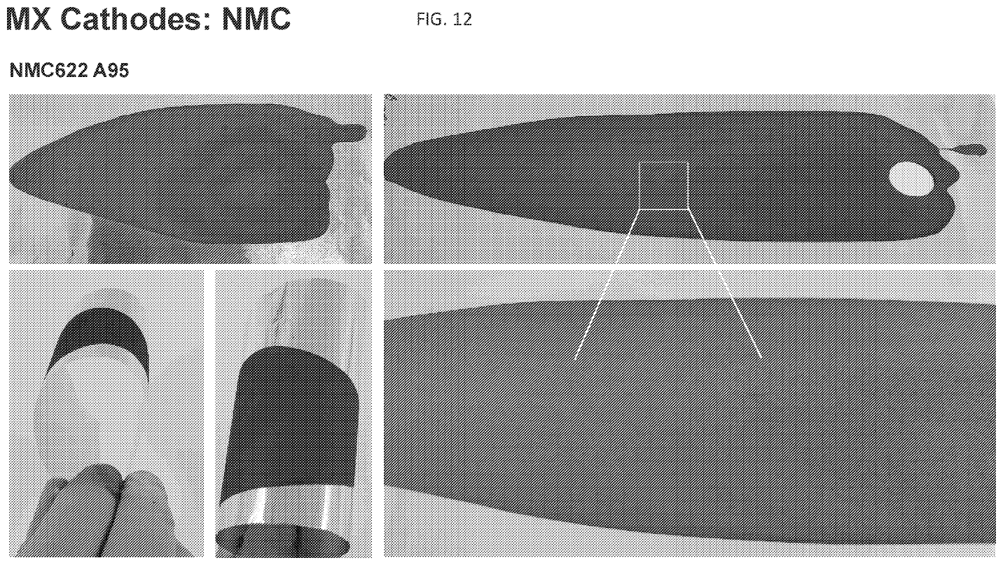

FIG. 13 provides exemplary voltage profiles of a NCA cathode with 95 wt. % active material in the electrode composition and a mass loading of 14 mg cm⁻² in a Li-ion half-cell (vs Li metal anode) between 2.8 V and 4.4 V (vs Li/Li⁺) at a c-rate of 0.25C (4 h charge-discharge)—left graph. The right graph shows the voltage profiles of the same cathode at a rate of 0.5C (2 h charge-discharge) at cycles 1, 10, 20, 25, and 30 in a Li-ion half-cell.

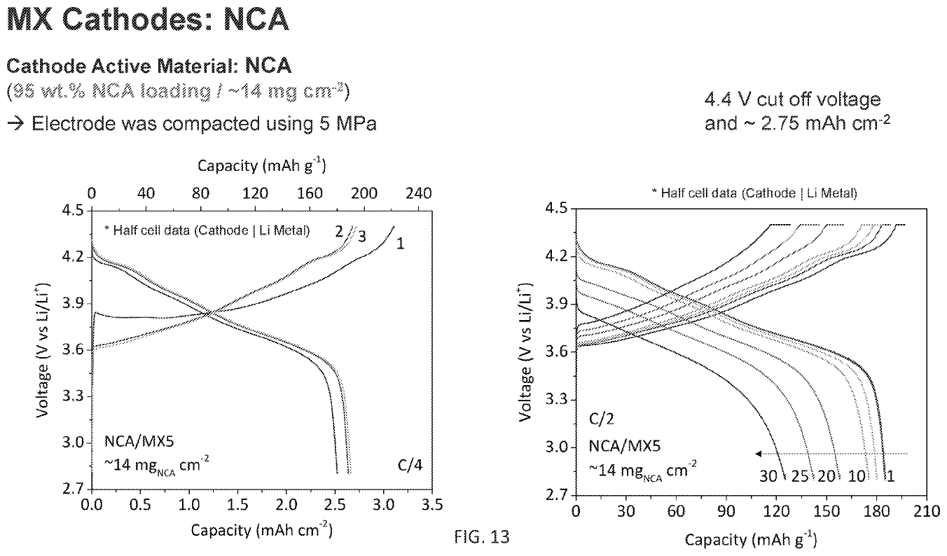

FIG. 14 provides scanning electron microscopy (SEM) images of the cross section of NCA-MXene cathode with 95 wt. % active material in its composition. The left image shows the as cast and dried electrode, and the right image shows the same electrode after calendaring (compaction).

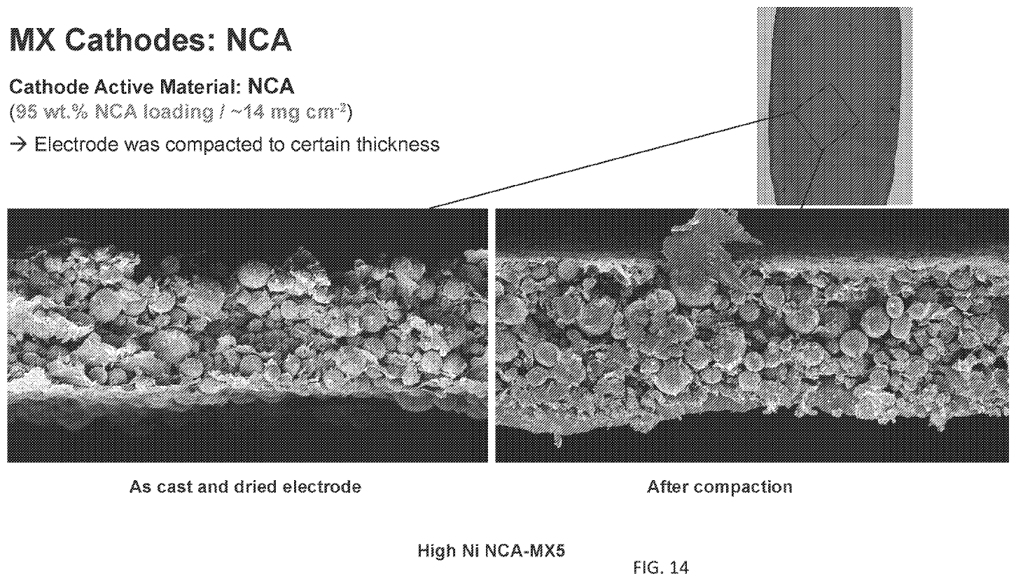

FIG. 15 provides exemplary voltage data for compositions according to the present disclosure.

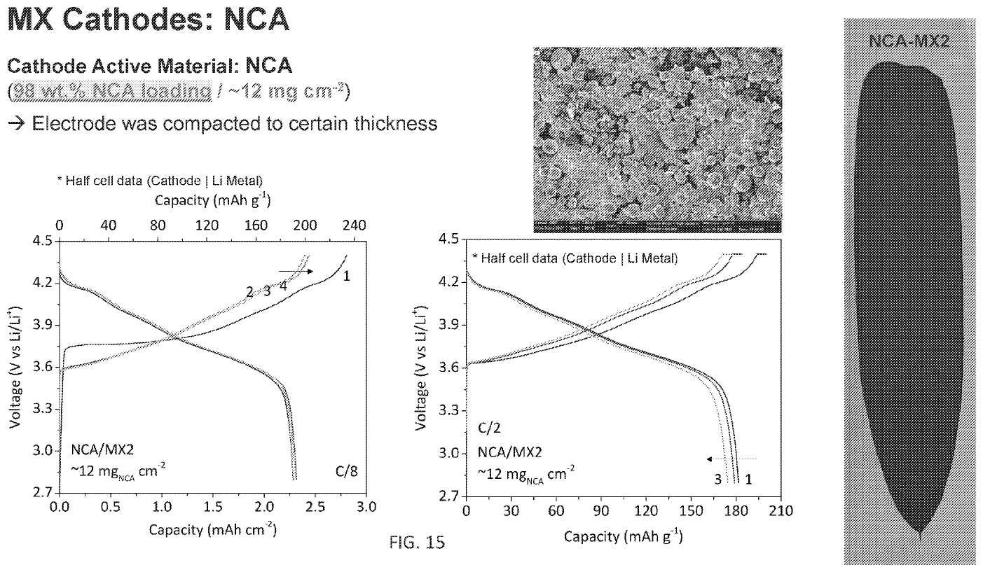

FIG. 16 provides an illustration of increasing the active material percentage inside the MXene containing electrode composition to up to 98 wt. %. The bottom left image shows voltage profiles of two NCA-MXene cathode with 98 wt. % and 95 wt. % active material loadings between 2.8 V and 4.4 V (vs Li/Li⁺) in a Li-ion half-cell at a rate of 0.5C. On the right, is provided specific capacity and Columbic efficiency (CE) vs cycle number for the NCA-MXene cathode with 98 wt. % active material at a rate of 0.5C in a Li-ion half-cell is shown. The first 4 cycles show the formation cycles at a rate of 0.125C.

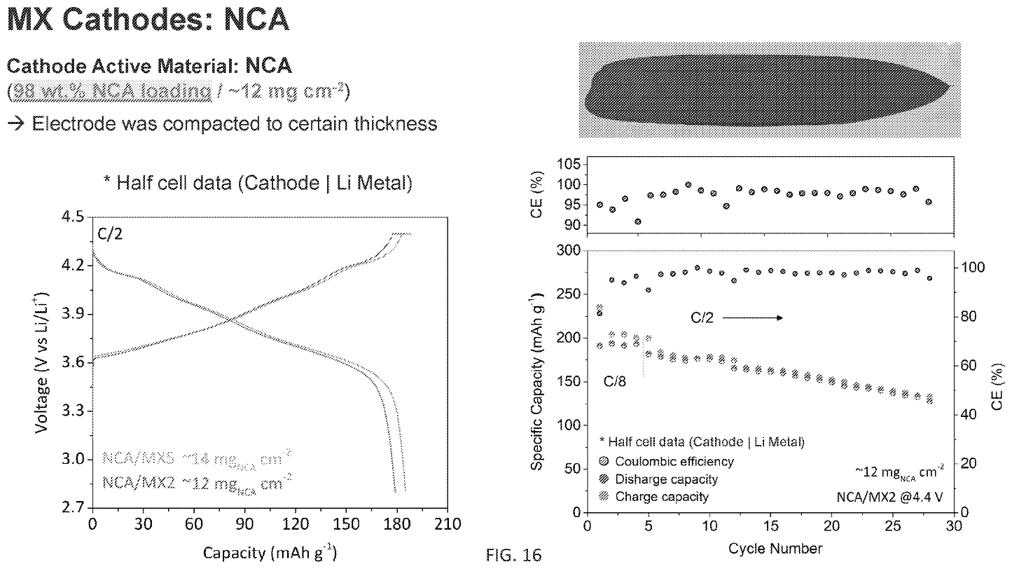

FIG. 17 provides exemplary electrochemical characterization results for LiFePO₄ (LFP)-MXene cathodes according to the present disclosure. The LFP cathodes shown have 90 wt. % active material in their composition. The left graph shows voltage profiles of a low mass loading LFP 90 wt. %-MXene cathode between 2.8 V and 3.8 V (vs Li/Li⁺) in a Li-ion half-cell at different C-rates. The middle graph shows specific capacity and CE of the same cathode half-cell vs cycle number and at different rates shown, demonstrating extraordinary rate retention and rate performance of the LFP-MXene cathode. The right graph shows proof of concept to prepare high mass loading LFP cathodes with an aerial capacity of 2.5 mAh cm⁻². An exemplary voltage profile of the LFP cathode between 2.7 and 3.9V (vs Li/Li⁺) at a rate of 0.25C is shown.

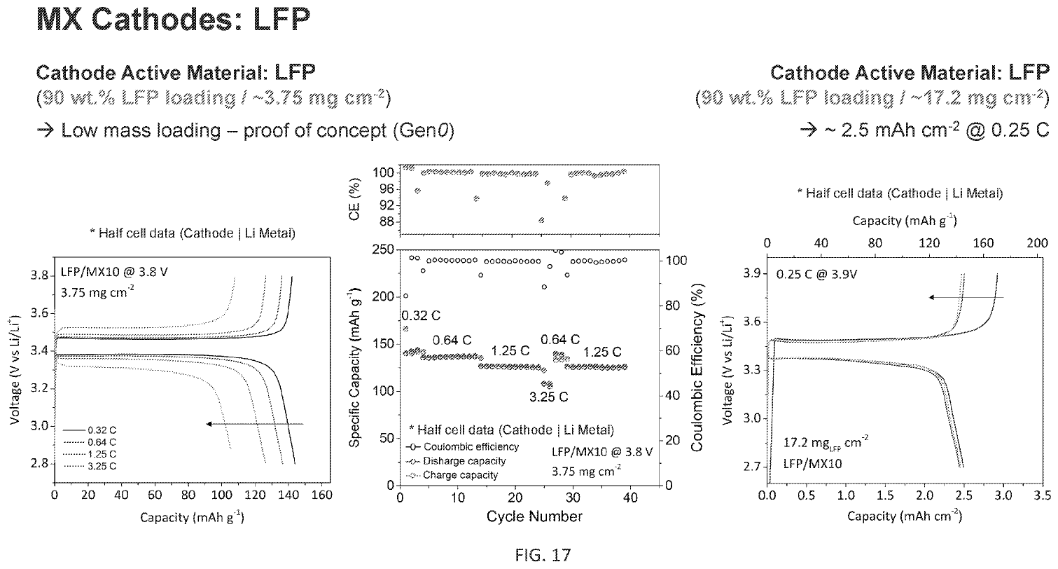

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (for example, “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” may be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### Overview

Most of the research in development of the next generation high-performance Li-ion batteries is focused on active materials (primarily, on using high-capacity conversion or alloying anodes but also cathodes). This is driven by the ever-growing need for high-voltage and high-capacity material systems and architectures that can provide two main capabilities: fast charging and stable and long cycling performance. Aside enormous research and development done on high-capacity anode materials such as silicon and phosphorous, as well as state-of-the-art Ni-rich oxide cathodes, the engineering of the architecture of electrodes (passive components) and the battery cells has not changed much in the past decade. This is particularly important for development of the next-generation batteries that need to meet certain cost and performance metrics, because, when looking at the cell level, passive components such as current collectors, conductive additives, binders, and separators constitute around 20 wt. % of each battery cell. Therefore, optimization of these components in electrode architectures and battery cells cannot only boost the performance and life cycle of batteries but also can reduce the cost, increase the production rate, and also ease the electrode processing and overall manufacturing of battery cells.

These so-called passive components while do not directly contribute to the charge storage, their weight, volume, and composition have a profound effect on the overall performance of the active material and therefore the battery cell. Among, different passive components inside a battery cell, conductive additives and binders that are used to form the electrode structure and coatings on the metallic current collectors are of profound importance. This is mainly due to their role in charge transport inside the electrode, processing of electrodes, and also overall cost, charge storage properties, and cycle life of the produced electrodes. Despite this, they usually receive less attention in development of high power and energy density batteries. If these components are re-engineered or substituted with alternative new materials, potentially, one can improve the performance (energy and power metrics) of a Li-ion battery cell by up to 20%, which is of significance value to the battery industry.

Provided here is a novel electrode composition, processing, and fabrication technique that can be used to prepare binder-free battery electrodes with high active material loading through using safe and green solvents such as water and ethanol. The claimed electrode processing technique provides various advantageous that makes electrodes comparable or better than the ones made using current industrial scale manufacturing processes. Also provided is a battery electrode composition in which both, conductive additive, and polymeric binders, are substituted with two-dimensional (2D) transition metal carbides and nitrides, MXenes, with a nominal formula of Mₙ₋₁XₙTₓ where M is a transition metal (Ti, V, Nb, Mo, Ta, Cr, etc.) X is carbon/nitrogen, Tₓ represents various surface functional groups, and n=1-4, and use aqueous based solvents to form slurries with over 90 wt. % cathode active materials (practical electrodes with up to 98 wt. % active materials have been processed) having appropriate rheological behaviors for tape casting/blade coating techniques that enable fabrication of battery electrode coatings on top of conventional and commercially available current collectors.

MXenes are highly electrically conductive materials (electrical conductivity of about 20,000 S cm⁻²) that can provide sufficient electronic charge transport properties inside the electrode to substitute the conductive additive. In the meantime, their 2D nature and mechanical robustness and flexibility as well as adhesion to metallic substrates enables them to act as a binder to connect cathode active materials particles together and to the metallic current collector substrate, therefore, substituting the conventional polymeric binders that require NMP organic solvent and cannot be processed in aqueous based solvents. The disclosed novel electrode processing technique is unique since through several optimization of battery electrode slurries and adjustment of the disclosed MXene additive rheological and material properties, one can use commercially acceptable active material loadings (>90 wt. %) and areal capacities (>3 mAh cm⁻²), while using aqueous based solvents with low drying temperatures, which enable ultrafast drying of the processed electrodes at lower temperatures (<90° C.) compared to those currently used in the industry (>100° C.).

A non-limiting list of the advantages of the disclosed technology is provided below:
The technology is applicable to a wide variety of commercially available active materials. This includes cathode active materials such as: various Lithium Nickel Manganese Cobalt (NMC, i.e., LiNiMnCoO₂) oxides with different stoichiometry compositions i.e., NMC111, NMC622, NMC811, NMC333, NMC523; Lithium iron phosphate (LFP i.e., LiFePO₄); Lithium Nickel Cobalt Aluminum (NCA i.e., LiNiCoAlO₂) oxides with Ni contents of above 85%; Lithium Cobalt Oxides (LCO i.e., LiCoO₂); Lithium Nickel Manganese Spinel with various stoichiometric ratios (LNMO, i.e., LiNiMnO₂); Lithium Manganese Oxide (LMO i.e. LiMn₂O₄); Lithium Vanadyl Phosphate (LiVOPO₄) Other layered Lithium transition metal oxide cathodes that contain Li, Mn, Nb, V, Co as well as emerging Co-free layered Li transition metal oxide materials.
Unlike current conventional electrode processing and fabrication approaches that are being used in the industry, which use a toxic, expensive, and dangerous organic solvent such as N-Methyl-2-pyrrolidone (NMP) to form a slurry that can be used to cast electrodes on a metallic current collector such as Al (in cathode, positive electrodes) and Cu (in anode, negative electrodes), the disclosed process altogether eliminate use of such solvents and instead only uses water or alcohol or both to form slurries with appropriate rheological behavior that can be coated on commonly used current collectors (for example, Al or Cu) in the battery industry. This provides a significant ease in processing of the electrodes as aqueous based solvents are safe and cheaper compared to NMP.
Because NMP is replaced with water/alcohol (for example, ethanol) in the disclosed technique, the battery and electrode processing facility would not require a NMP recovery system, which can both significantly reduce the initial capital investment, as well manufacturing cost of the electrodes.
Aqueous-based cathode slurries. The disclosed process mitigates the widely known degradation of cathode active materials in water-based slurries, which are mainly caused by their chemical sensitivity in aqueous solutions where Li leaches out of the structure of these materials (NMC, NCA, etc.) and results in formation of highly basic battery slurries. Therefore, not only the material structure is being affected, but also, since the slurries have highly basic pH, when coated on Al current collectors, they corrode the surface of current collector and cause several challenges including improper adhesion, low charge transport, and altogether negatively affect the electrochemical performance of the electrode. The disclosed cathode slurry formulation enables us to suppress these and do water-based processing of a wide-variety of cathode materials.
The disclosed electrode processing technology is completely compatible with currently used equipment and large-scale battery electrode manufacturing facilities, and requires no or minimal modifications, therefore, it can be readily transferred into industrial settings, minimizing the time to market of the technology, and eliminating the need for large and extra capital investments for creating electrode processing and manufacturing lines.
The disclosed cathode compositions incorporate highly conductive 2D MXene additives that improve their impedance and charge carrying properties during battery cycling compared to conventional cathode electrodes and show minimal increase in their impedance after hundreds of cycles.

### Figures

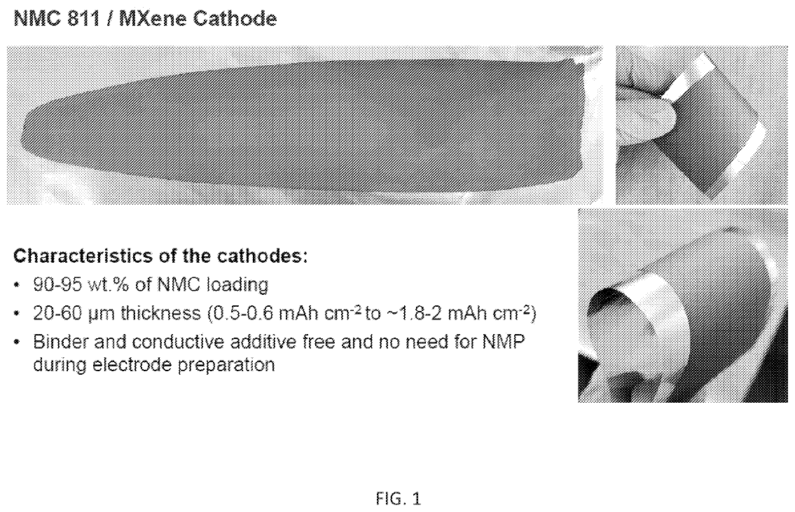

FIG. 1 provides a schematic representation of the polymeric binder-free cathode compositions with at least 85 wt. % of active material powder in the cathode composition, processed through water-based slurries with Ti₃C₂ MXene additives.

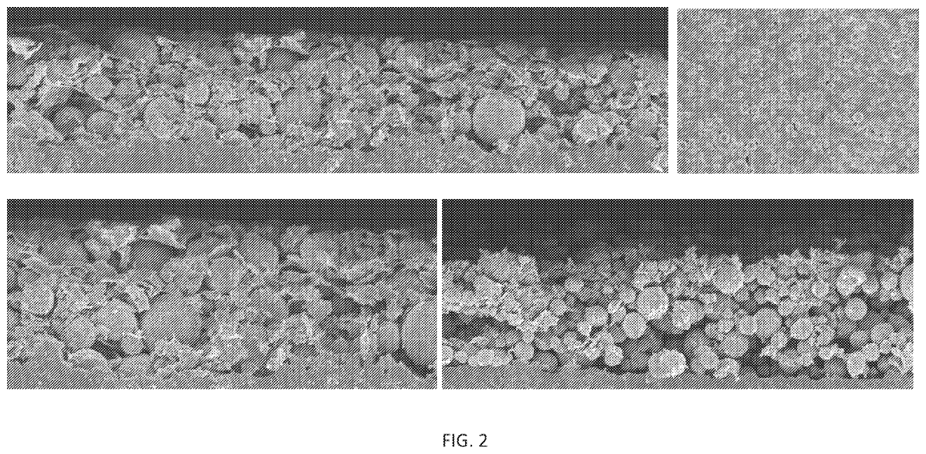

FIG. 2 illustrates polymeric binder-free NMC 811 cathodes with 90 wt. % of active material powder in the cathode composition, processed through water-based slurries with Ti₃C₂ MXene additives.

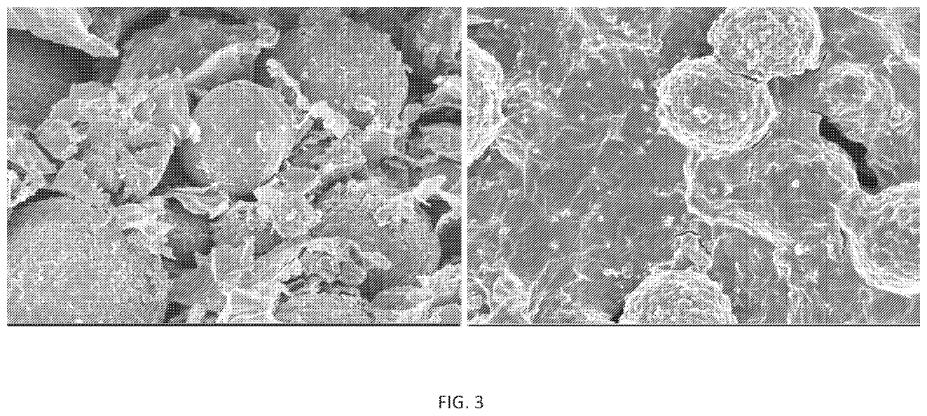

FIG. 3 illustrates charge discharge profiles of a polymeric binder-free NMC 811 cathodes with 97 wt. % of active material powder in the cathode composition, processed through water-based slurries with Ti₃C₂ MXene additives. The cathode has an active material loading of ˜29.35 mg cm⁻² and at C/8 rate could deliver areal capacities of ˜4.9 mAh cm⁻² and 4 mAh cm⁻² at 4.3V and 4.2 V, respectively.

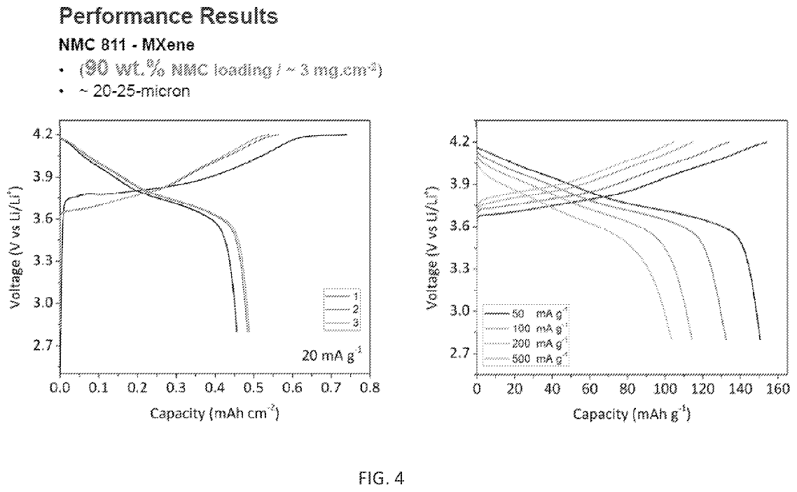

FIG. 4 illustrates polymeric binder-free (a) NMC₆₂₂ and (b) NCA, cathodes with 95 wt. % of NMC₆₂₂ and 98 wt. % of NCA active material powders in the cathode composition, respectively, processed through water-based slurries with Ti₃C₂ MXene additives.

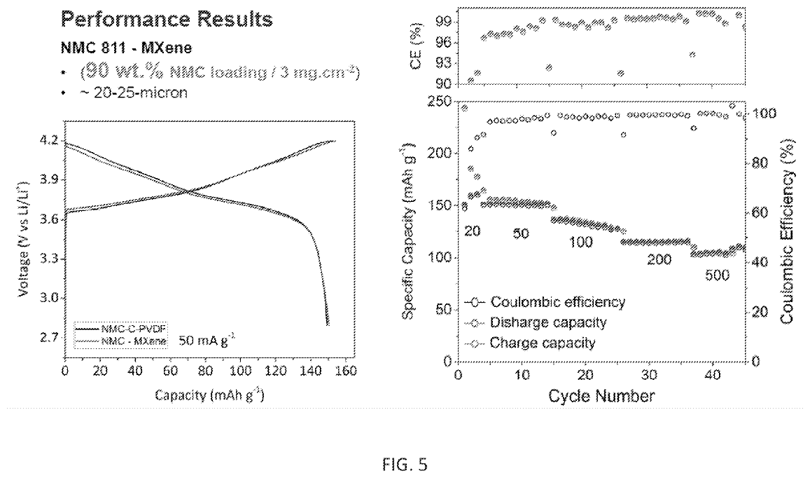

FIG. 5 illustrates (a) Charge discharge profiles of a polymeric binder-free NMC₆₂₂ with 97 wt. % of active material powder in the cathode composition, processed through water-based slurries with Ti₃C₂ MXene additives at a rate of C/4, and (b) Cycle life performance of a polymeric binder-free NMC₆₂₂ with 90 wt. % of active material powder in the cathode composition processed through water-based slurries with Ti₃C₂ MXene additives at a rate of C/2.

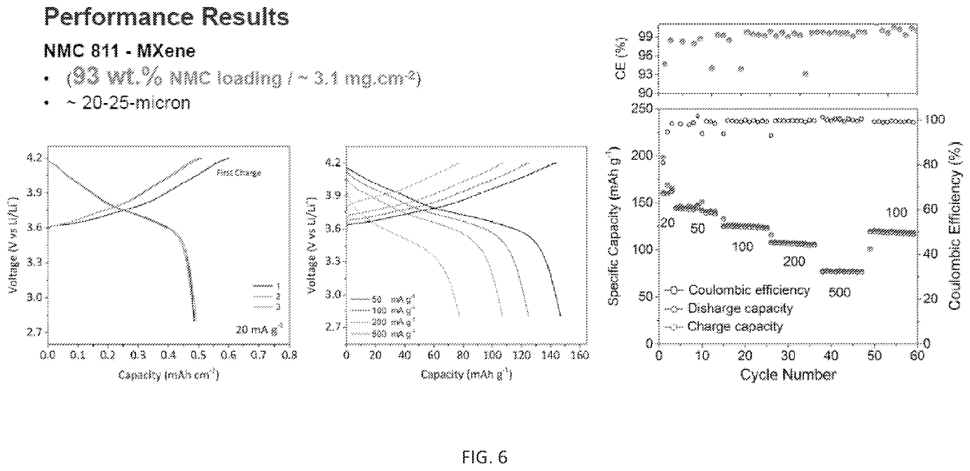

FIG. 6 illustrates (a) Scanning electron microscope (SEM) image from a cross section of a NCA cathode with 95 wt. % active material powder in the electrode composition, processed through water-based slurries with Ti₃C₂ MXene additives. (b) Charge discharge profiles of a NCA cathode with 95 wt. % active material powder in the electrode composition, processed through water-based slurries with Ti₃C₂ MXene additives. The cathode has an active material loading of ˜14 mg cm⁻² and an areal capacity of ˜2.6 mAh cm⁻² at C/4 rate.

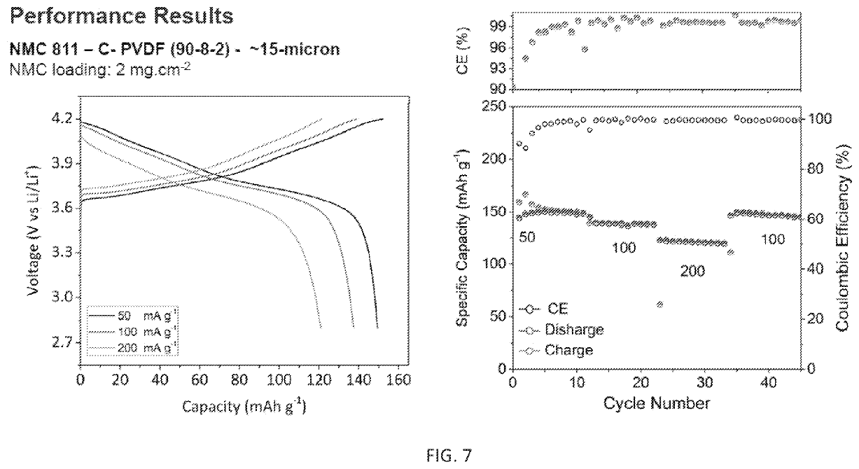

FIG. 7 provides charge discharge profiles of a NCA cathode with 98 wt. % active material powder in the electrode composition, processed through water-based slurries with Ti₃C₂ MXene additives at (a) C/8 and (b) C/2 rates. The cathode has an active material loading of ˜12 mg cm⁻² and an aerial capacity of ˜2.3 mAh cm⁻² at C/8 rate.

### Aspects

The following Aspects are illustrative only and do not limit the scope of the present disclosure or the appended claims. Any part or parts of any one or more Aspects can be combined with any part or parts of any one or more other Aspects.

Aspect 1. A method, comprising: combining at least a MXene, a solvent, and an electrochemically active material to form a slurry, the solvent consisting essentially of water, alcohol, or a combination of alcohol and water.

The solvent can be a non-toxic or “green” solvent, for example, a solvent that consists essentially or one or both of water and alcohol. Ethanol is considered a particularly suitable alcohol, as is isopropyl alcohol (IPA).

Aspect 2. The method of Aspect 1, wherein the slurry is free of N-Methyl-2-pyrrolidone (NMP). The slurry can also be free of polyvinylidene fluoride (PVDF), and can also be free of other binders.

Aspect 3. The method of any one of Aspects 1-2, wherein the active material comprises one or more of nickel manganese cobalt (NMC), lithium cobalt oxide (LCO), lithium iron phosphate (LFP).

The disclosed technology can be applied to various lithium nickel manganese cobalt (NMC, i.e., LiNiMnCoO₂) oxides with different stoichiometry compositions i.e., NMC111, NMC622, NMC811, NMC333, NMC523; Lithium iron phosphate (LFP i.e., LiFePO₄); Lithium Nickel Cobalt Aluminum (NCA i.e., LiNiCoAlO₂) oxides with Ni contents of above 85%; Lithium Cobalt Oxides (LCO i.e., LiCoO₂); Lithium Nickel Manganese Spinel with various stoichiometric ratios (LNMO, i.e., LiNiMnO₂); Lithium Manganese Oxide (LMO i.e. LiMn₂O₄); Lithium Vanadyl Phosphate (LiVOPO₄). Other layered lithium transition metal oxide cathodes that contain Li, Mn, Nb, V, Co as well as emerging Co-free layered Li transition metal oxide materials can also be used in the disclosed technology.

Aspect 4. The method of any one of Aspects 1-3, further comprising disposing the slurry onto a substrate, the substrate optionally being conductive. Example substrates include, for example, copper, aluminum. molybdenum, nickel, tantalum, carbon cloth, conductive metal foils, and the like.

Aspect 5. The method of any one of Aspects 1-4, further comprising removing the solvent from the slurry to give rise to a dried composition. In some embodiments, all solvent is removed from the slurry so as to leave behind a dried composition.

Aspect 6. The method of Aspect 5, wherein the dried composition is at least about 70 wt % active material. The dried composition can be at least about 70 wt % active material, at least about 75 wt % active material, at least about 85 wt % active material, at least about 90 wt % active material, or even at least about 95 wt % active material.

Aspect 7. The method of Aspect 6, wherein the dried composition is at least about 90 wt % active material.

Aspect 8. The method of Aspect 7, wherein the dried composition is at least about 95 wt % active material, preferably at least about 97 wt % active material.

Aspect 9. The method of any one of Aspects 4-8, further comprising calendaring the disposed slurry.

Aspect 10. The method of any one of Aspects 4-9, wherein the method is performed to give rise to a structure. The structure can have a cross-sectional dimension of from about 1 to about 300 μm in thickness, preferably from about 10 to about 100 μm. The structure can have a thickness of from, for example, about 5 to about 200 μm, or even from about 10 to about 100 μm.

Aspect 11. The method of Aspect 10, wherein the structure is a film.

Aspect 12. The method of any one of Aspects 10-11, wherein the film has a porosity of less than about 40%.

Aspect 13. A cathode, the cathode made according to the method of any one of Aspects 1-12.

Aspect 14. An electrode, comprising: a structure comprising a MXene and an electrochemically active material, the structure optionally having a cross-sectional dimension of from about 1 to about 300 μm in thickness, preferably from about 10 to about 100 μm in thickness; and optionally a substrate on which the structure is disposed. The structure can be, for example, a film.f

Aspect 15. The electrode of Aspect 14, wherein the structure is at least about 70 wt % electrically active material. The structure can be at least about 70 wt % active material, at least about 75 wt % active material, at least about 85 wt % active material, at least about 90 wt % active material, or even at least about 95 wt % active material.

Aspect 16. The electrode of Aspect 15, wherein the structure is at least about 90 wt % electrically active material.

Aspect 17. The electrode of any one of Aspects 14-16, wherein the electrode is characterized as a cathode.

Aspect 18. The electrode of any one of Aspects 14-17, comprising a substrate on which the structure is disposed. The substrate can be, for example, a metal, a polymer, and the like.

Aspect 19. The electrode of any one of Aspects 14-18, wherein the structure is free-standing.

Aspect 20. The electrode of any one of Aspects 14-19, wherein the structure is characterized as a film. The film can have a thickness in the range of, for example, from about 1 to about 300 μm, as well as all intermediate values.

Aspect 21. A device, the device comprising an electrode according to any one of Aspects 14-19.

Aspect 22. The device of Aspect 21, wherein the device is an energy storage device. An energy storage device can be comprised in, for example, a mobile device, such as a computing device, a communications device, or a combination thereof.

Aspect 23. A method, comprising operating a device according to any one of Aspects 21-22.

### Summary

Herein is provided polymeric binder- and conductive carbon-free Li battery cathodes (positive electrodes) with high active material mass loading (>90 wt. %) prepared by using two-dimensional (2D) transition metal carbides (MXenes) as the only additive and without the need for conventional toxic solvents such as N-Methyl-2-pyrrolidone (NMP) widely used in the industry. The cathode electrodes are prepared from water or alcohol (for example, ethanol) containing slurries having the active material of choice (NMC, LCO, LFP, etc.) and MXene material. The disclosed prepared slurries can be cast on conventional Al current collectors or be used to prepare freestanding electrodes with varying thicknesses required in the battery industry.

The disclosed technology provides a number of advantages compared to current technology used in the industry:
Eliminates the need for toxic and expensive solvents such as N-Methyl-2-pyrrolidone (NMP) for cathode slurry preparation
Enables the use of “green” and inexpensive cheap solvents such as water and ethanol for electrode slurry preparation
Eliminates the need for expensive and non-conductive polymeric binders (such as PVDF, CMC, etc.) and also conductive carbon additives in electrode preparation
Enables lower electrode drying temperatures with shorter times due to the absence of non-volatile toxic solvents
Enables polymeric binder-free cathode electrodes with high (>90 wt. %) active material mass loading
Improves charge transfer inside the cathode electrode

1. A method, comprising:
combining at least MXene, a solvent, and an electrically active material to form a slurry,
the solvent consisting essentially of water, alcohol, or a combination of ethanol and water.

2. The method of claim 1, wherein the slurry is free of N-Methyl-2-pyrrolidone (NMP).

3. The method of claim 1, wherein the active material comprises one or more of nickel manganese cobalt (NMC), lithium cobalt oxide (LCO), and lithium iron phosphate (LFP), oxides with different stoichiometry compositions i.e., NMC111, NMC622, NMC811, NMC333, NMC523: Lithium iron phosphate (LFP i.e., LiFePO₄); Lithium Nickel Cobalt Aluminum (NCA i.e., LiNiCoAlO₂) oxides with Ni contents of above 85%: Lithium Cobalt Oxides (LCO i.e., LiCoO₂): Lithium Nickel Manganese Spinel with various stoichiometric ratios (LNMO, i.e., LiNiMnO₂): Lithium Manganese Oxide (LMO i.e. LiMn₂O₄); Lithium Vanadyl Phosphate (LiVOPO₄). Other layered Lithium transition metal oxide cathodes that contain Li, Mn, V, Co, and Co-free layered Li transition metal oxide materials.

4. The method of claim 1, further comprising disposing the slurry onto a substrate, the substrate optionally being conductive.

5. The method of claim 1, further comprising removing the solvent from the slurry to give rise to a dried composition.

6. The method of claim 5, wherein the dried composition is at least about 70 wt % active material.

7. The method of claim 6, wherein the dried composition is at least about 90 wt % active material.

8. The method of claim 7, wherein the dried composition is at least about 95 wt % active material.

9. The method of claim 4, further comprising calendaring the disposed slurry.

10. The method of claim 4, wherein the method is performed to give rise to a structure, the structure optionally having a cross-sectional dimension of from about 1 to about 300 μm in thickness, preferably from about 10 to about 100 μm.

11. The method of claim 10, wherein the structure is a film.

12. The method of claim 11, wherein the film has a porosity of less than about 40%.

13. A cathode, the cathode made according to the method of claim 1.

14. An electrode, comprising:
a structure comprising a MXene and an electrically active material,
the structure optionally having a cross-sectional dimension of from about 1 to about 300 μm in thickness, preferably from about 10 to about 100 μm; and
optionally a substrate on which the structure is disposed.

15. The electrode of claim 14, wherein the structure is at least about 70 wt % electrically active material.

16. The electrode of claim 15, wherein the structure is at least about 90 wt % electrically active material.

17. The electrode of claim 14, wherein the electrode is characterized as a cathode.

18. The electrode of claim 14, comprising a substrate on which the structure is disposed.

19. The electrode of claim 14, wherein the structure is free-standing.

20. The electrode of claim 14, wherein the structure is characterized as a film.

21. A device, the device comprising an electrode according to claim 14.

22. The device of claim 21, wherein the device is an energy storage device.

23. A method, comprising operating a device according to claim 21.
